(19) United States
(12) Patent Application Publication
(10) Pub. No.: US 2012/0100421 A1
(43) Pub. Date: Apr. 26, 2012

(54) SECONDARY BATTERY

(75) Inventors: Keizo Oda, Osaka (JP); Masahiko Kubo, Hyogo (JP); Hajime Nishino, Nara (JP); Akitoshi Hiramatsu, Aichi (JP); Takayuki Oota, Aichi (JP)

(73) Assignee: Panasonic Corporation, Osaka (JP)

(21) Appl. No.: 13/379,987

(22) PCT Filed: Oct. 15, 2010
(86) PCT No.: PCT/JP2010/006122

§ 371 Date: Dec. 21, 2011

(30) Foreign Application Priority Data
Oct. 19, 2009 (JP) 2009-240176
Jun. 25, 2010 (JP) 2010-145112

(51) Int. Cl. H01M 2/08

(52) U.S. Cl. 429/185

(57) ABSTRACT

Disclosed is a battery 10 including: an electrode group including a positive electrode, a negative electrode, and a separator; an electrolyte; and a battery container accommodating the electrode group and the electrolyte. The battery container includes an accommodating portion 16 having an opening, and a lid sealing the opening of the accommodating portion 16. The battery container includes a liquid-retaining portion 16a retaining the electrolyte therein below the liquid surface of the electrolyte, and a gas-retaining portion 16b retaining gas therein above the liquid surface of the electrolyte. The liquid-retaining portion 16a of the side portion of the battery container is thinner than the gas-retaining portion 16b of the battery container. This suppresses scattering of fragments etc. in the event of rupture of a secondary battery due to an increase in the internal pressure. The safety of the secondary battery is thus increased.

### TECHNICAL FIELD

The present invention relates to secondary batteries, such as lead-acid batteries, having a structure for suppressing scattering of fragments of a battery container and electrolyte.

### BACKGROUND ART

Secondary batteries, such as lead-acid batteries, nickel-cadmium batteries, nickel-metal hydride batteries, and lithium ion batteries, can be charged and used repeatedly, and therefore, are widely used as vehicle-mounted power sources, power sources for portable electronic devices, or power sources for power storage equipment. With widespread use of secondary batteries, the risk of misuse thereof, such as overcharging, over-discharging or reverse connection, is increased. If a secondary battery is misused, although it depends on its type, electrolyte leakage or battery rapture may occur.

For this reason, in recent years, particularly with regard to lithium ion secondary batteries to be used as power sources for portable electronic devices, many of them are available in the form of a battery pack including one or two or more batteries accommodated in a case. The shape and capacity of the battery pack are designed for use as a power supply applicable for a single model load device. As such, the operation of its charger can be optimized according to the characteristics of the battery pack, and at the same time, a mechanism for reliably preventing overcharging or over-discharging can be incorporated into the battery pack. In addition, the direction and posture in which the batteries are to be mounted on the load device can be regulated by the shape of a battery pack, and therefore, reverse connection also can be prevented.

On the other hand, with regard to other secondary batteries such as lead-acid batteries, nickel-metal hydride batteries, and nickel-cadmium batteries, many of them are available as a power supply applicable for various devices, rather than available in a form specialized to a power supply applicable for a single model load device. As such, in order to prevent misuse of these secondary batteries, such as overcharging or reverse connection, there has been no other way than to alert users by, for example, putting a designation on the battery case to indicate how to charge and how to use.

Further, with regard to, for example, lead-acid batteries, flammable gas (e.g., hydrogen gas) may be filled inside the battery container in the event of misuse such as overcharging or reverse connection. If the flammable gas filled inside the battery container ignites for some reason, the internal pressure of the battery container increases abruptly, and the battery container may break.

Because of this, in these secondary batteries, it is preferable to provide a suppression structure for suppressing scattering of electrolyte and fragments due to breakage of the battery container. In this regard, Patent Literature 1 discloses providing a groove-like thin portion on the lid of the battery container in a lead-acid battery, in order to suppress scattering of electrolyte and fragments.

Patent Literature 2 discloses providing thin portions at biased positions on opposite side walls of the battery case. Patent Literature 3 discloses covering the top surface of the lid of the battery case with a plastic cover.

### CITATION LIST

### Patent Literature

[PTL 1] Japanese Laid-Open Utility Model Publication No. Sho 63-135760
[PTL 2] Japanese Laid-Open Utility Model Publication No. Sho 57-20775
[PTL 3] Japanese Laid-Open Patent Publication No. Sho 63-19752

### SUMMARY OF INVENTION

### Technical Problem

In the case of merely providing a groove-like thin portion on the lid as disclosed in Patent Literature 1, it may be impossible to sufficiently suppress the destruction energy, upon an abrupt increase in the internal pressure caused by ignition of the flammable gas inside the battery container. If the destruction energy is not suppressed, breakage of the battery container propagates starting from the thin portion, which may form larger-size fragments or cause a severe spillage of electrolyte.

Furthermore, for example, in some lead-acid batteries, the interior of the battery container is divided into several chambers. In such lead-acid batteries, if a thin portion as disclosed in Patent Literature 1 or 2 is provided on the lid or side walls of the battery container, when the flammable gas ignites in one of the chambers, and the internal pressure in the chamber increases, to cause the thin portion to rupture, other parts of the thin portion extending to other chambers may rapture simultaneously. As a result, the electrolyte may spill out or the fragments may scatter also from the chambers in which no abrupt increase in the internal pressure has occurred.

Further, in the case where the lid of the battery container of a secondary battery is covered with a cover made of, for example, a plastic sheet, as disclosed in Patent Literature 3, it may be difficult to connect a power cable to the electrode terminal which is usually provided on the lid of the battery container, or the operation of refilling electrolyte may be complicated. Moreover, since breakage of the battery container occurs not only at the lid but also at the side portion, providing a cover on the lid of the battery container is not enough to sufficiently suppress scattering of electrolyte and fragments.

The present invention was made in view of the above problems, and intends to prevent the battery container of a secondary battery, if broken due to an increase in the internal pressure thereof, from being broken over a large area, thereby to suppress fragments and electrolyte from being scattered.

### Solution to Problem

One aspect of the present invention relates to a secondary battery including: an electrode group including a positive electrode, a negative electrode, and a separator; an electrolyte; and a battery container including an accommodating portion having an opening and accommodating the electrode group and the electrolyte, and a lid sealing the opening of the accommodating portion. The battery container includes a liquid-retaining portion retaining the electrolyte therein below a liquid surface of the electrolyte, and a gas-retaining portion retaining gas therein above the liquid surface of the electrolyte. The liquid-retaining portion has a thin portion.

### Advantageous Effects of Invention

According to the present invention, it is possible to prevent the case of a secondary battery, if broken due to an increase in the internal pressure thereof, from being broken over a large area, thereby to suppress fragments and electrolyte from being scattered.

While the novel features of the invention are set forth particularly in the appended claims, the invention, both as to organization and content, will be better understood and appreciated, along with other objects and features thereof, from the following detailed description taken in conjunction with the drawings.

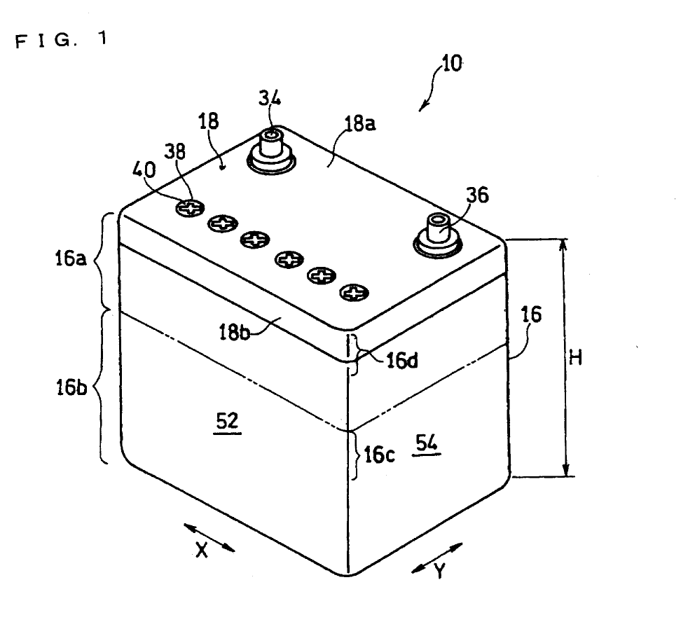

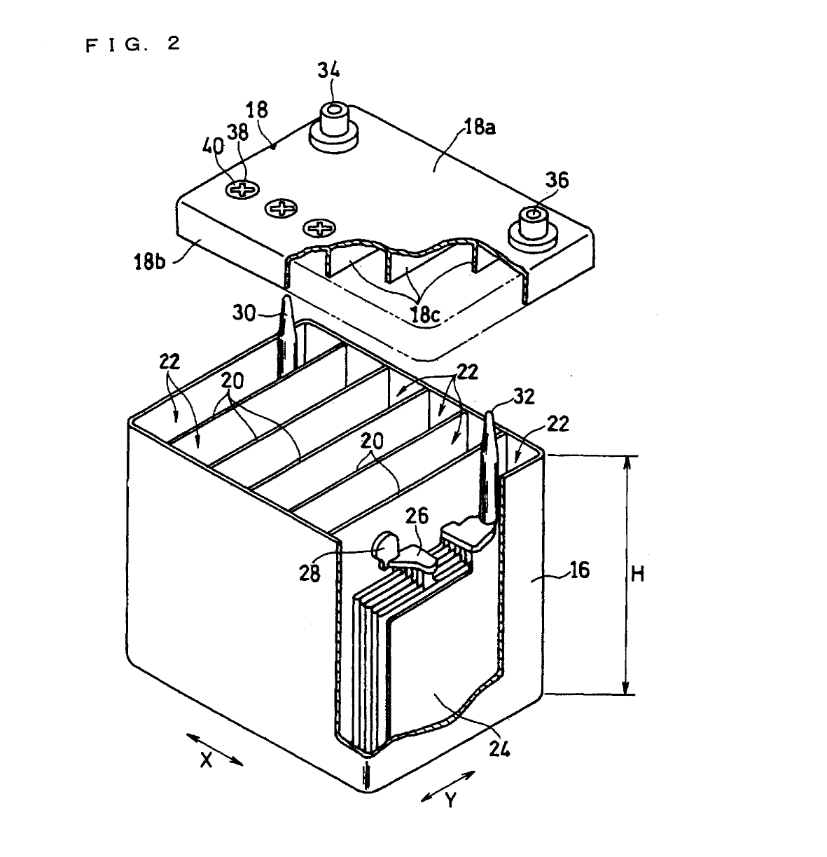

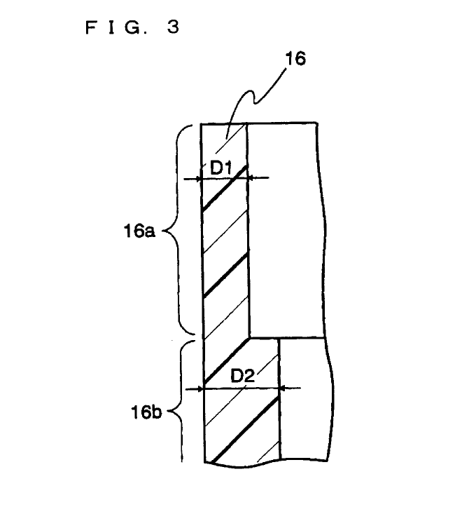

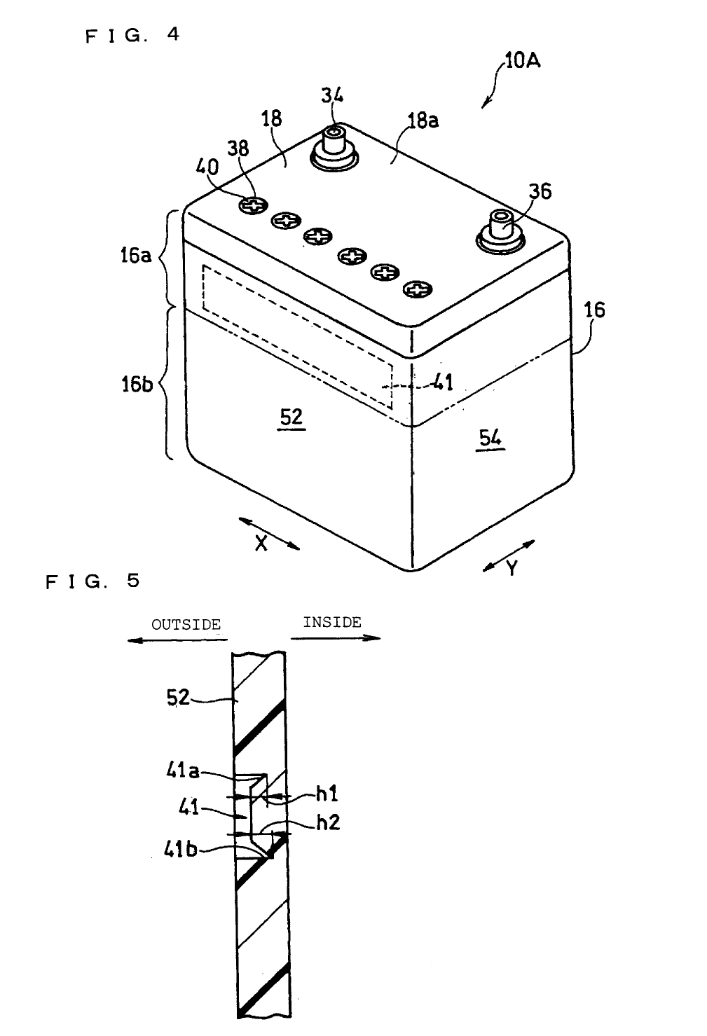

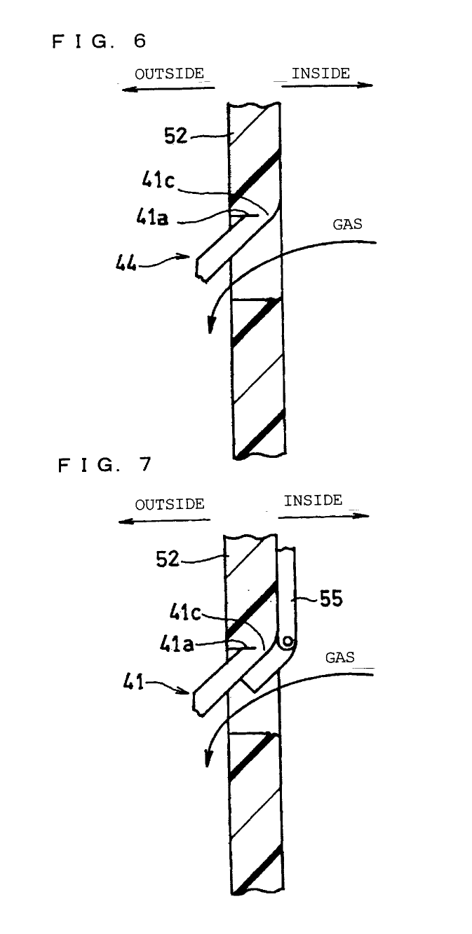

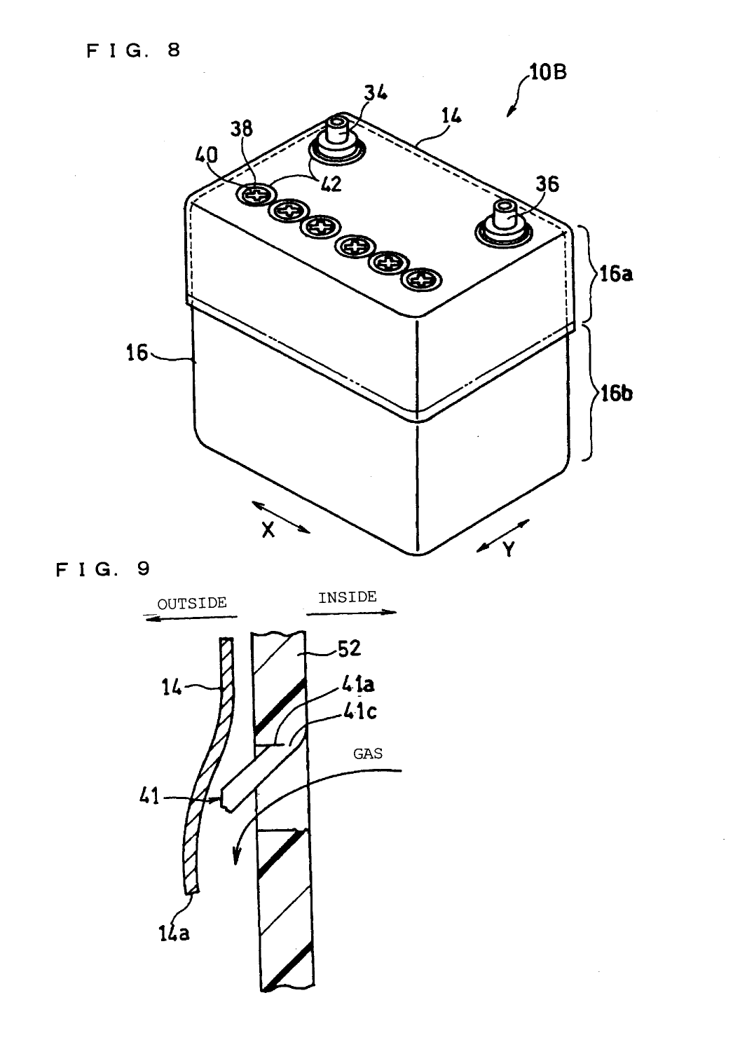

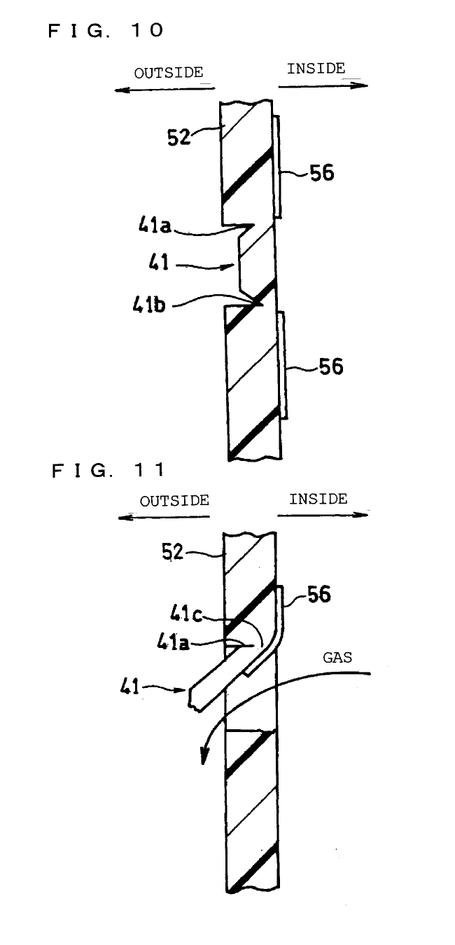

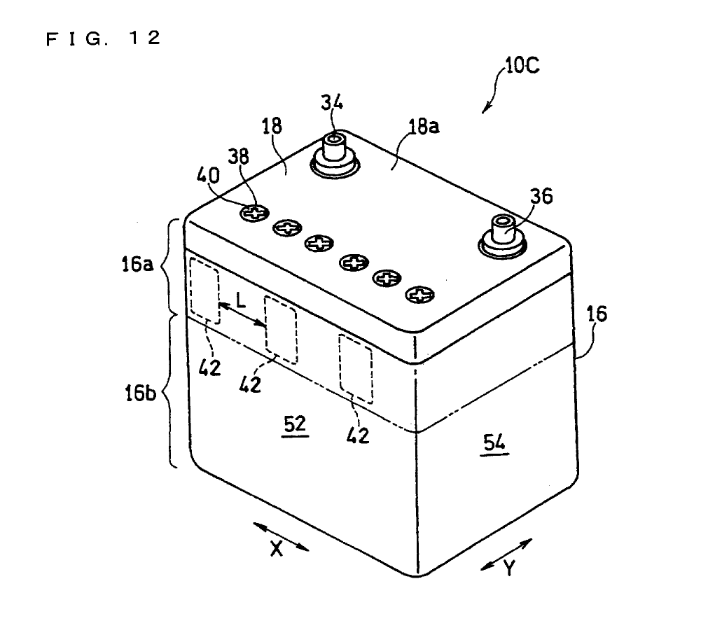

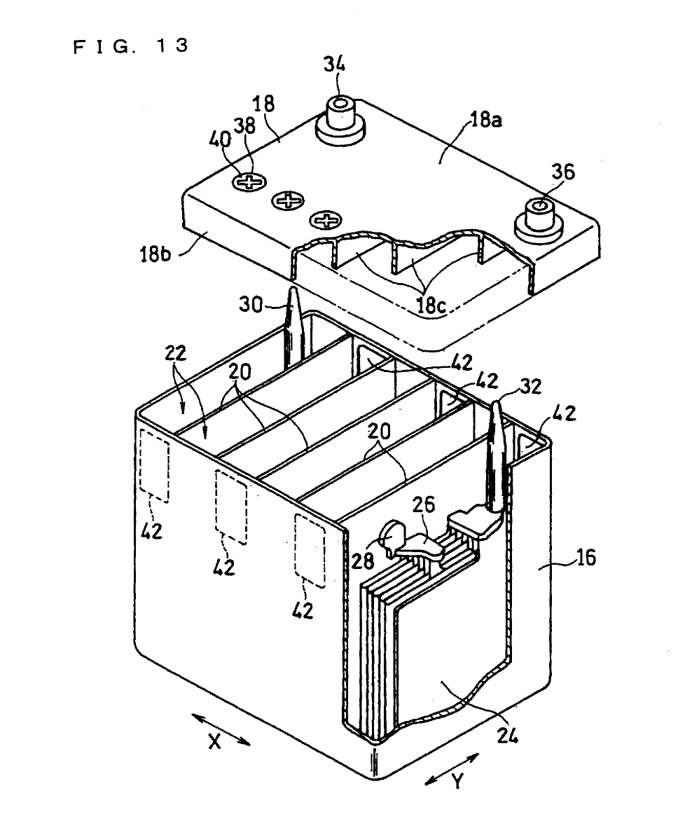

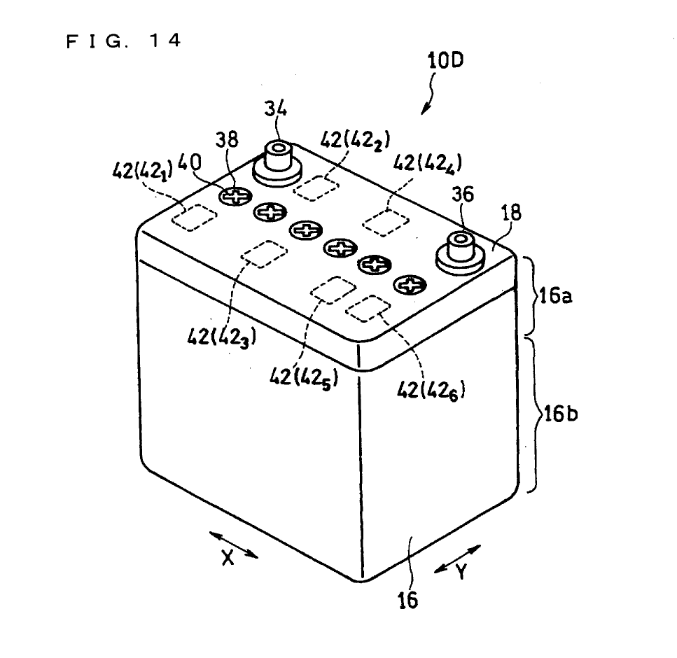

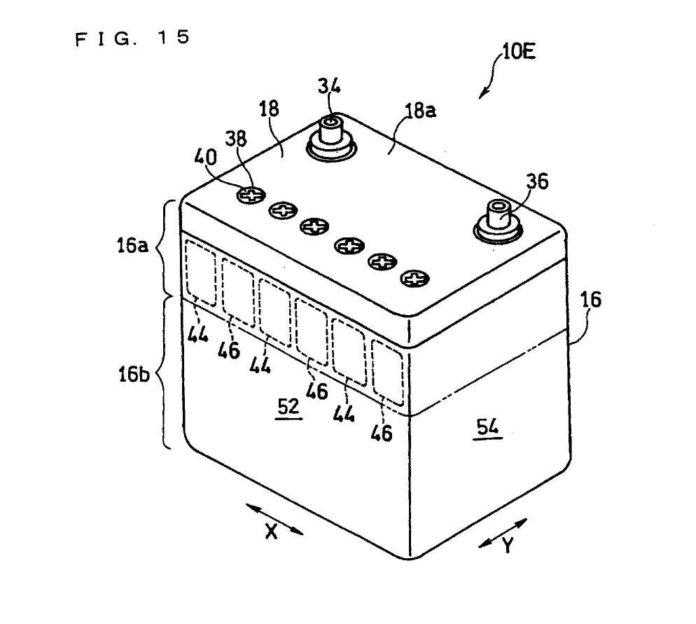

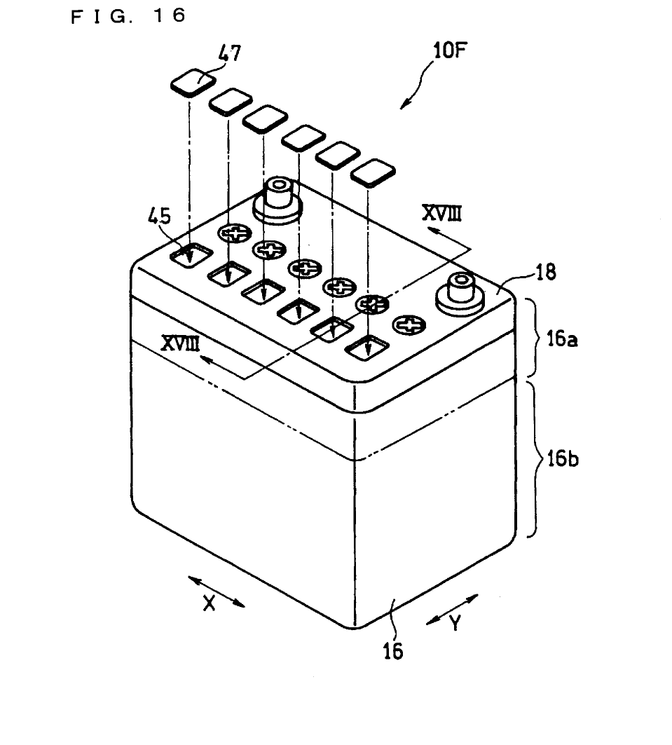

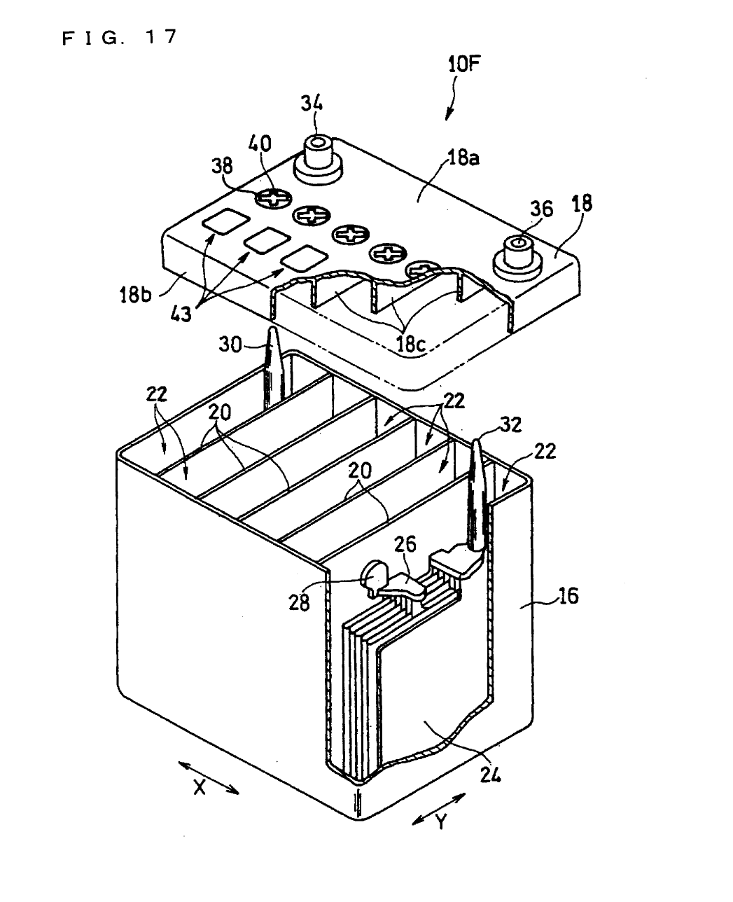

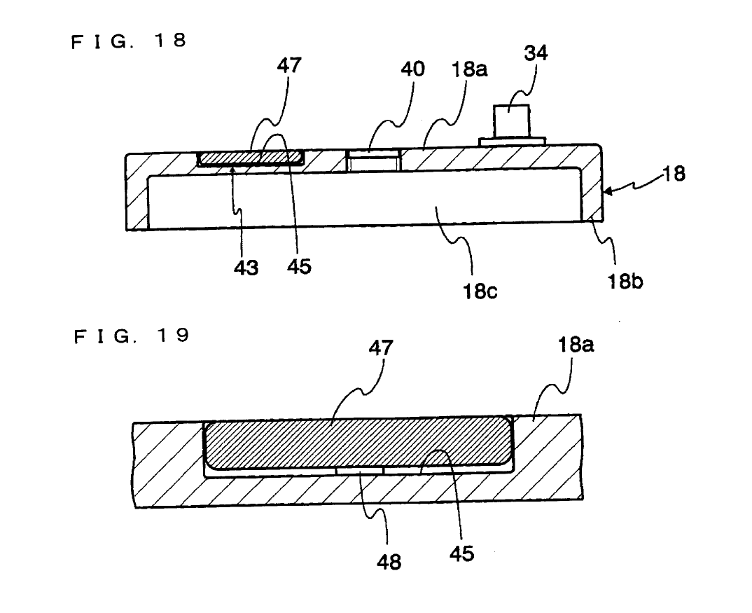

### BRIEF DESCRIPTION OF DRAWINGS

[FIG. 1] An oblique view showing the appearance of a secondary battery according to Embodiments 1 and 2 of the present invention.

[FIG. 2] A partially cut-away oblique view showing the internal structure of the secondary battery according to Embodiments 1 and 2.

[FIG. 3] An enlarged cross-sectional view of a thin portion of the secondary battery according to Embodiment 1.

[FIG. 4] An oblique view showing the appearance of a secondary battery according to Embodiment 3 of the present invention.

[FIG. 5] An enlarged cross-sectional view of a thin portion of the secondary battery according to Embodiment 3.

[FIG. 6] An enlarged cross-sectional view showing the ruptured state of the thin portion of the secondary battery according to Embodiment 3.

[FIG. 7] An enlarged cross-sectional view showing the ruptured state of a thin portion of a secondary battery according to a variant example of Embodiment 3.

[FIG. 8] An oblique view showing the appearance of a secondary battery according to Embodiments 4 and 5 of the present invention.

[FIG. 9] An enlarged cross-sectional view of a thin portion of the secondary battery according to Embodiment 4.

[FIG. 10] An enlarged cross-sectional view of a thin portion of the secondary battery according to Embodiment 5.

[FIG. 11] An enlarged cross-sectional view showing the ruptured state of a thin portion of a secondary battery according to a variant example of Embodiment 5.

[FIG. 12] An oblique view showing the appearance of a secondary battery according to Embodiment 6 of the present invention.

[FIG. 13] A partially cut-away oblique view showing the internal structure of the secondary battery according to Embodiment 6.

[FIG. 14] An oblique view showing the appearance of a secondary battery according to Embodiment 7 of the present invention.

[FIG. 15] An oblique view showing the appearance of a secondary battery according to Embodiment 8 of the present invention.

[FIG. 16] An oblique view showing the appearance of a secondary battery according to Embodiment 9 of the present invention.

[FIG. 17] A partially cut-away oblique view showing the internal structure of the secondary battery according to Embodiment 9.

[FIG. 18] An enlarged fragmentary cross-sectional view of FIG. 16.

[FIG. 19] An enlarged cross-sectional view showing a thin portion of the secondary battery according to Embodiment 9.

### DESCRIPTION OF EMBODIMENTS

The present invention relates to a secondary battery including: an electrode group which includes a positive electrode, a negative electrode, and a separator; an electrolyte; and a battery container including an accommodating portion which has an opening and accommodates the electrode group and the electrolyte, and a lid sealing the opening of the accommodating portion. The battery container includes a liquid-retaining portion retaining the electrolyte therein below a liquid surface of the electrolyte, and a gas-retaining portion retaining gas therein above the liquid surface of the electrolyte. The liquid-retaining portion has a thin portion.

The gas-retaining portion of the battery container is a portion in which flammable gas generated by misuse of a secondary battery such as overcharging or reverse connection is accumulated. Since the thin portion is provided on the gas-retaining portion, the thin portion on the liquid-retaining portion ruptures early, when the flammable gas accumulated inside the battery container ignites for some reason, and the internal pressure increases abruptly. As such, breakage of the liquid-retaining portion is suppressed. It is possible, therefore, to prevent generation of larger-size fragments, as well as to suppress scattering of electrolyte.

In one embodiment of the present invention, the interior of the battery container is divided into a plurality of chambers by at least one partition, and each of the chambers accommodates the electrode group and the electrolyte. The thin portion is formed on the gas-retaining portion independently in each of the chambers.

Since the thin portion is formed independently in each of the chambers inside the battery container, even if the flammable gas ignites in one of the chambers and the internal pressure in the chamber increases abruptly, the thin portion in the chamber ruptures early, which can prevent the partition from being broken. As such, it will not happen that the flammable gas in other chambers ignites one after another, to cause the battery container to being broken on a large scale. It is possible, therefore, to more effectively suppress scattering of electrolyte and fragments.

In anther embodiment of the present invention, the accommodating portion includes: a substantially rectangular bottom portion having a pair of long sides and a pair of short sides; and a side portion having a pair of short-side side walls being opposite to each other and being raised from the pair of short sides of the bottom portion, and a pair of long-side side walls being opposite to each other and being raised from the pair of long sides of the bottom portion. The at least one partition is in the form of a plate and substantially parallel to the pair of short-side side walls. The thin portions are formed in a staggered arrangement with respect to either the long-side side walls or the lid. Each of the chambers has a shape of a rectangular prism, in which a pair of opposite end surfaces is defined by a pair of long-side side walls, and another pair of opposite end surfaces is defined by the bottom portion and the lid.

In a vehicle-mounted lead-acid battery, the interior of the battery container is generally divided into a plurality of chambers, and the chambers are usually separated from each other by partitions perpendicular to the longitudinal direction of the battery container. If the thin portions of each of the chambers are aligned adjacently to each other on one of the long-side side wall, because of a small distance between the thin portions in adjacent chambers, a rupture of one of the thin portions, if occurs, may cause the thin portions adjacent thereto to rupture, too.

In view of the above, in this embodiment, the thin portions of each of the chambers are arranged in a staggered arrangement (or arranged zigzag) with respect to either the lid or the side portion, rather than being aligned in a line. By arranging the thin portions in a staggered arrangement, the distance between the adjacent thin portions can be made larger than when the thin portions are aligned in a line. As such, it is possible to prevent a rupture of one of the thin portions from causing other thin portions to rupture. Therefore, scattering of electrolyte and fragments can be suppressed. Further, the strength of the battery container can be improved.

One possible arrangement of the thin portions on the side portion of the battery container in a staggered arrangement is such that one of the thin portions of two of the chambers adjacent to each other is provided on one of the pair of long-side side walls, and the other of the thin portions of two of the chambers adjacent to each other is provided on the other of the pair of long-side side walls. By arranging the thin portions zigzag between the pair of long-side side walls as described above, the distance between the thin portions can be made larger than at least the thickness of each chamber.

Another possible arrangement of the thin portions on the side portion of the battery container in a staggered arrangement is such that the thin portions are arranged in a staggered arrangement on one of the pair of long-side side walls by alternating the vertical positions of the thin portions. By arranging as above also, the distance between the thin portions can be made larger to some extent.

One possible arrangement of the thin portions on the lid of the battery container in a staggered arrangement is such that one of the thin portions of two of the chambers adjacent to each other is provided on the lid at a position closer to one of the pair of long-side side walls, and the other of the thin portions of two of the chambers adjacent to each other is provided on the lid at a position closer to the other of the pair of long-side side walls.

In yet another embodiment of the present invention, the thin portion has a substantially rectangular shape with an upper end and a lower end, and has a first groove formed along the upper end and a second groove formed along the lower end. The second groove is deeper than the first groove.

Since the second groove is deeper than the first groove, the lower end of the thin portion along which the second groove is formed tends to rupture more easily than the upper end. When the internal pressure of the battery container increases, the lower end of the thin portion ruptures earlier than the upper end, increasing the possibility that the upper end is left unruptured. In the situation where the upper end of the thin portion remains and only the lower end ruptures, the gas inside the battery container is ejected obliquely downward. As such, even if the electrolyte in the battery container spouts out, it also spouts out obliquely downward. It is possible, therefore, to prevent the electrolyte from being scattered widely.

In still another embodiment of the present invention, the thin portion is formed by providing a recess on an outer surface of the gas-retaining portion. Further, a protective member for protecting the thin portion is arranged in the recess.

Providing a thin portion on the battery container makes the strength of the thin portion smaller than that of the other portion. Hence, if the thin portion collides with another member made of metal, the battery container is more likely to break than when the other portion collides therewith. In other words, providing a thin portion on the battery container makes the battery container more susceptible to breakage by interference from outside.

In this regard, when the thin portion is formed on the inner surface of the battery container by, for example, providing a notch as disclosed in Patent Literatures 1 and 2, the thin portion thus formed is flushed with the outer surface of the battery container. In contrast, in this embodiment, the thin portion is formed on the outer surface of the battery container by providing a recess. The thin portion thus formed is recessed from the outer surface of the battery container. This reduces the risk of a collision of the thin portion with another member. Further, by arranging a protective member in the recess, a direct collision of the thin portion with another member can be avoided. It is possible, therefore, to suppress the thin portion from being broken by interference from another member. Examples of the material of the protective member include a gel material, a rubber sheet, a fabric, and a soft resin material.

It is preferable that the recess has a flat bottom, and 90% or more of the bottom is covered with the protective member. When, for example, the thin portion is formed by providing a notch on the wall of the battery container, stress is concentrated thereon, and the battery container may be easily broken by impact due to dropping of the secondary battery and the like. In contrast, when the thin portion is formed by providing a recess with a flat bottom, the thin portion thus formed is flat, and concentration of stress can be avoided. It is possible, therefore, to prevent the battery container from being easily broken by impact due to dropping of the secondary battery and the like.

Furthermore, if the internal pressure of the battery container increases abruptly, when the thin portion is notch-like or groove-like, the rupture may spread over a large area starting from the thin portion. In contrast, when the thin portion has a flat bottom, the rupture tends not to spread beyond the thin portion. In addition, since fragments from the thin portion are thin in thickness, the impact at the time of collision of the fragments with another member is small.

The width of the bottom is preferably set to from 10 to 90 mm. Alternatively, it is preferably set to from 10 to 60 mm or from 10 to 30 mm, depending on the size of the secondary battery. The “width” as used herein refers to: provided that the bottom is rectangular, the length of the short side; provided that the bottom is circular, the diameter; provided that the bottom is elliptic, the shorter diameter; and provided that the bottom is stripe-shaped, the width of the stripe.

It is further preferable that the thin portion has a substantially rectangular shape when viewed from above, and the longitudinal direction thereof is parallel to the longitudinal direction of the chamber when viewed from above. By providing the thin portion as above, even if the thin portion ruptures, the rupture tends to occur as a crack along the longitudinal direction of the chamber when viewed from above. As such, the rupture of the thin portion in one chamber is unlikely to be extended to the chambers adjacent thereto. Therefore, breaking of the battery container on a large scale can be prevented, and scattering of fragments and electrolyte can be effectively suppressed.

It is furthermore preferable that the protective member is in the form of a plate with an upper surface substantially parallel to the bottom of the recess and a lower surface facing the bottom of the recess, and has a thickness equal to or shorter than the maximum depth of the recess. By configuring as above, the protective member is prevented from protruding higher than the opening of the recess. As such, the protective member can be provided so as not to protrude from the surface of the battery container. As a result, the quality in appearance of the secondary battery will not be lowered, and it will not happen that the protective member protrudes outside and contacts an external object more than necessary.

In yet another embodiment of the present invention, the accommodating portion includes: a substantially rectangular bottom portion having a pair of long sides and a pair of short sides; and a side portion having a pair of short-side side walls being opposite to each other and being raised from the pair of short sides of the bottom portion, and a pair of long-side side walls being opposite to each other and being raised from the pair of long sides of the bottom portion. The at least one partition is in the form of a plate and is substantially parallel to the pair of short-side side walls. One of the strong thin portions of two of the chambers adjacent to each other is provided on one of the pair of long-side side walls, and the other of the strong thin portions of two of the chambers adjacent to each other is provided on the other of the pair of long-side side walls.

In still another embodiment of the present invention, the accommodating portion includes: a substantially rectangular bottom portion having a pair of long sides and a pair of short sides; and a side portion having a pair of short-side side walls being opposite to each other and being raised from the pair of short sides of the bottom portion, and a pair of long-side side walls being opposite to each other and being raised from the pair of long sides of the bottom portion. The at least one partition is in the form of a plate and substantially parallel to the pair of short-side side walls. In each of the chambers, a strong thin portion having a comparatively higher strength and a weak thin portion having a comparatively lower strength are provided on the lid. One of the thin portions of two of the chambers adjacent to each other is provided on the lid at a position closer to one of the pair of long-side side walls, and the other of the thin portions of two of the chambers adjacent to each other is provided on the lid at a position closer to the other of the pair of long-side side walls.

Embodiments of the present invention are specifically described below with reference to drawings.

### Embodiment 1

FIG. 1 shows the appearance of a secondary battery according to Embodiment 1 of the present invention by an oblique view. FIG. 2 shows the internal structure of the same secondary battery. In FIG. 2, the case and lid are partially cut away to show the inner structure of the secondary battery.

A battery 10 shown in the figure includes an accommodating portion 16 which has an opening and accommodates a power generating element, and a lid 18 sealing the opening of the accommodating portion 16. The accommodating portion 16 and the lid 18 are collectively called a battery container. The power generating element includes an electrode group 24, and an electrolyte (not shown) comprising, for example, an aqueous sulfuric acid solution. The electrode group 24 includes a positive electrode, a negative electrode, and a separator interposed therebetween.

The accommodating portion 16 and the lid 18 are made of an insulating material. Examples of the insulating material include polypropylene, high density polyethylene, polystyrene, acrylic resin, styrene resin, and ABS resin.

Specifically, the accommodating portion 16 includes: a substantially rectangular bottom portion; and a side portion having a pair of long-side side walls 52 raised from the pair of long sides of the bottom portion, and a pair of short-side side walls 54 raised from the pair of short sides of the bottom portion.

The interior of the battery container composed of the accommodating portion 16 and the lid 18 is divided into a plurality of (“six” in the example shown in the figure) chambers (cells) 22 by at least one (“five” in the example shown in the figure) partition. Each partition is formed of a lower partition 20 for dividing the interior of the accommodating portion 16, and a below-described rib 18c, and is substantially parallel to the short-side side walls 54.

Each of the chambers 22 accommodates the electrode group 24 and an electrolyte. The electrode groups 24 in the chambers 22 adjacent to each other are connected in series via a strap 26 and a joint 28. The positive or negative electrodes of the electrode groups 24 accommodated in the chambers 22 at both ends of the accommodating portion 16 are connected to electrode posts 30 and 32 for the positive or negative electrodes.

The lid 18 includes: a top plate 18a having a substantially same shape as the bottom portion of the accommodating portion 16; a leg portion 18b extending downward by a predetermined length from the periphery of the top plate 18a; and the ribs 18c being provided to be aligned with the lower partitions 20 in the accommodating portion 16 and constituting the partitions together with the lower partitions 20. The accommodating portion 16 and the lid 18 are bonded to each other by welding the leg portion 18b to the upper end of the accommodating portion 16, and welding the ribs 18c to the lower partitions 20.

On the top surface of the top plate 18a of the lid 18, a pair of electrode terminals 34 and 36 to which the electrode posts 30 and 32 are connected respectively are provided at positions near both ends in the longitudinal direction of the battery container (hereinafter, “the longitudinal direction X”) and near one end in the lateral direction of the battery container (hereinafter, “the lateral direction Y”). Further, at positions near the other end in the lateral direction Y on the top surface of the top plate 18a, a plurality of electrolyte injection ports 38 for injecting electrolyte therethrough to the chambers 22 are provided so as be aligned at equal intervals in the longitudinal direction X. Each of the electrolyte injection ports 38 is sealed with a plug 40.

The accommodating portion 16 is filled with an electrolyte generally such that the liquid level reaches 70 to 80% of the depth H (the inside dimension) of the accommodating portion 16. Gas such as air is present above the liquid surface of the electrolyte in the battery container. Accordingly, the upper portion of the battery container (i.e., 20 to 30% of the side portion of the accommodating portion 16 from the top, plus the lid 18) constitutes a gas-retaining portion 16a for retaining gas therein. On the other hand, the lower portion of the battery container (i.e., 70 to 80% of the side portion of the accommodating portion 16 from the bottom, plus the bottom portion of the accommodating portion 16) constitutes a liquid-retaining portion 16b for retaining electrolyte therein.

In the battery 10, as shown in FIG. 3, the average thickness D1 of the gas-retaining portion 16a is smaller than the average thickness D2 of the liquid-retaining portion 16b. Accordingly, in the battery 10 shown in the figure, all or almost all (e.g., 80% or more) of the gas-retaining portion 16a on the side portion of the battery container is the thin portion. As a result, the strength (e.g., the tensile strength) of the gas-retaining portion 16a on the side portion of the battery container is smaller than that of the liquid-retaining portion 16b.

As such, if the gas-retaining portion 16a is filled with a flammable gas (e.g., hydrogen gas) generated by, for example, overcharging, and the gas ignites to cause the internal pressure of the battery container to increase abruptly, first, somewhere in the gas-retaining portion 16a on the side portion of the battery container ruptures early. This suppresses any further increase in the internal pressure, and therefore, rupture of the liquid-retaining portion 16b can be prevented. As a result, spillage of the electrolyte from the liquid-retaining portion 16b can be prevented.

In addition, since the thin portion breaks in an early stage, accumulation of the destruction energy can be prevented. This means that the energy to cause scattering of electrolyte and fragments is reduced. As such, even if the electrolyte and fragments are scattered, they will not scatter over a large area, and the damage caused by the scattering can be minimized. Further, since fragments of the thin portion are thin in thickness, scattering of fragments becomes less dangerous. As a result of the foregoing, the safety of the secondary battery can be improved.

The ratio of the average thickness D1 of the gas-retaining portion 16a to the average thickness D2 of the liquid-retaining portion 16b may be set to, for example, 40 to 60%, although not limited thereto. By setting this ratio to 60% or less, the gas-retaining portion 16a can easily rupture early when the internal pressure increases. On the other hand, by setting this ratio to 40% or more, provided that the battery container has a general level of strength, the gas-retaining portion 16a is unlikely to rupture easily, even when a large external force is applied to the battery container, for example, when the battery is dropped inadvertently, or when the gas-retaining portion 16a collides with another member.

Likewise, the ratio of the average tensile strength of the gas-retaining portion 16a to the average tensile strength of the liquid-retaining portion 16b may be set to, for example, 60 to 70%, although not limited thereto. The average thickness can be determined by measuring the thicknesses at predetermined several points (e.g., 10 points) on the flat portion except the portion where the thickness is particularly greatly different from the other portion, such as the corners or a protruded portion, in each of the gas-retaining portion 16a and the liquid-retaining portion 16b, and averaging the measured thicknesses.

### Embodiment 2

Next, Embodiment 2 of the present invention is described. A secondary battery of Embodiment 2 is the same as the battery 10 of Embodiment 1 in terms of appearance, and therefore, the description here is given with reference to FIGS. 1 and 2.

In the secondary battery of Embodiment 2, of the side portion of the battery container, only the gas-retaining portion 16a on the long-side side walls 52 has a smaller average thickness than the liquid-retaining portion 16b. The gas-retaining portion 16a on the short-side side walls 54 has the same average thickness as the liquid-retaining portion 16b.

By forming the thin portion on all or almost all (e.g., 80% or more) of the gas-retaining portion 16a on the long-side side walls 52 as described above, of the side portion of the battery container, a portion which is subjected to a larger force than the other portion when the internal pressure increases becomes a thin portion. Hence, the effect almost similar to that obtained in Embodiment 1 can be achieved. In addition, the ratio of the thin portion in the battery container becomes smaller than that in Example 1, and therefore, the strength of the battery container is less reduced. Hence, it is possible to suppress scattering of fragments and electrolyte, while reducing the possibility that the battery container is broken by external force applied thereto.

It should be noted that a configuration in which all or almost all of the gas-retaining portion 16a on the short-side side walls 54 is the thin portion, and the gas-retaining portion 16a on the long-side side walls 52 has the same average thickness as the liquid-retaining portion 16b is a variant example of this embodiment, which is encompassed by the present invention.

### Embodiment 3

Next, Embodiment 3 of the present invention is described with reference to FIG. 4. FIG. 4 is an oblique view showing the appearance of a secondary battery according to Embodiment 3. In a battery 10A shown in the figure, the thin portion is formed on only a part of the gas-retaining portion 16a on the long-side side walls 52.

Specifically, in the battery 10A shown in the figure, a rectangular thin portion 41 whose longitudinal direction is parallel to the longitudinal direction X is provided on the gas-retaining portion 16a on the long-side side walls 52. The long sides of the thin portion 41 coincide with the upper and lower ends of the thin portion 41. The short sides of the thin portion 41 are parallel to the vertical direction of the battery container. The thin portion 41 is preferably provided such that all the chambers 22 share the thin portion. By configuring as above, even if the internal pressure increases in any one of the chambers 22, the thin portion 41 can be opened such that the gas inside the chamber 22 is released outside. The thin portion 41 may be provided on only one of the pair of the long-side side walls 52, or on both of them.

Further, as shown in FIG. 5, in the battery 10A shown in the figure, a first groove 41a is formed along the upper end of the thin portion 41, and a second groove 41b is formed along the lower end. The depth (i.e., the depth from the bottom of the thin portion 41) h2 of the second groove 41b is greater than depth h1 of the first groove 41a. As such, when the internal pressure of the battery container increases, the portion along the second groove 41b at the lower end ruptures more easily than the portion along the first groove 41a at the upper end.

As a consequence, as shown in FIG. 6, only the portion along the second groove 41b at the lower end ruptures, and an unruptured portion 41c is formed along the first groove 41a at the upper end. In this situation, the unruptured portion 41c functions like a hinge, and the thin portion 41 opens toward obliquely downward. As such, the gas inside the battery 10A is ejected downward as indicated by the arrow. Accordingly, if the electrolyte is splashed, the droplets of electrolyte will be scattered obliquely downward. This prevents the electrolyte from being scattered over a large area, making it possible to further improve the safety of the battery. The ratio h1/h2 of the depth h1 of the first groove 41a to the depth h2 of the second groove 41b may be set to, for example, ⅓ to ½, although not limited thereto.

The first and second grooves as described above are applicable to the thin portion of the battery according to the above-described or below-described embodiments, and these variant examples are encompassed by the present invention.

The area of the thin portion 41 is preferably set to, for example, 30 to 65 cm² for 80D26 batteries, although not limited thereto. When the area of the thin portion 41 is below 30 cm², since the area is too small, the thin portion 41 may not rupture early. On the other hand, when the area of the thin portion 41 exceeds 65 cm², the strength of the battery container 16 may decrease abruptly. A more preferred area of the thin portion 41 is 40 to 50 cm².

It is also preferable to provide a groove having almost the same depth as the second groove 41b along each of the right and left ends of the thin portion 41. This allows the thin portion 41 to more reliably open obliquely downward.

The cross-sectional shape of each of the grooves 41a and 41b is may be, without limitation, a U-shape, a rectangular shape, or a triangular shape. However, with regard to the second groove 41b, the cross-sectional shape thereof is preferably tapered to a point at the bottom (a wedge-shape) so that rupture can easily occur. For example, the cross-sectional shape of the second groove 41b is preferably a triangular shape.

FIG. 7 shows a variant example of the secondary battery of Embodiment 3. In the battery shown in the figure, a hinge 55 is provided inside the battery so that the portion along the first groove 41a will not rupture when the internal pressure of the battery container increases. The hinge 55 is provided so as to extend over the thin portion 41 and the long-side side wall 52. This configuration allows the thin portion 41 to more reliably open obliquely downward. The first and second grooves and the hinge as described above are basically applicable to embodiments in which the thin portion 41 is provided on the short-side side wall(s) 54, and these embodiments are encompassed by the present invention.

### Embodiment 4

Next, Embodiment 4 of the present invention is described with reference to FIG. 8. FIG. 8 is an oblique view showing the appearance of a secondary battery according to Embodiment 4. Embodiment 4 is a variant of Embodiments 1 to 3. A battery 10B of Embodiment 4 is different from the batteries of Embodiments 1 to 3 in that the battery 10B is provided with a cover 14 for covering the gas-retaining portion 16a.

By providing the battery 10B with the cover 14, scattering of fragments and electrolyte can be more effectively suppressed when the thin portion ruptures due to an increase in the internal pressure of the battery container.

The cover 14 is preferably made of a material which is highly resistant to acidity, in view of the properties of the electrolyte. Examples of the material include: rubber materials, such as chloroprene rubber, ethylene-propylene rubber, natural rubber, synthetic isoprene rubber, styrene-isoprene-styrene rubber, and polyisoprene rubber; and resin materials, such as polyethylene, polypropylene, nylon, Teflon (registered trademark), polyvinyl chloride, ABS resin, polyacrylate, and silicone-based resin. Alternatively, the material may be a composite material of the above-listed material and ceramic.

The cover 14 is not limited to in the form of a plate, and may be in the form of a belt, sheet, mesh, fiber, or fabric.

In the case where the lid 18 is provided with the electrode terminals 34 and 36, and the electrolyte injection ports 38 as in the example shown in the figure, it is preferable, in view of the operability, to provide the cover 14 with holes at corresponding positions, for ease of connecting a power cable and refilling electrolyte. The “corresponding positions” as used here refer to positions at which the electrode terminal-mounted areas and the electrolyte injection ports can be easily accessed externally, while the cover 14 is attached to the battery 10B. Typically, they refer to positions facing the electrode terminal-mounted areas and the electrolyte injection ports.

In FIG. 8, the cover 14 is provided with a predetermined number (“eight” in the example shown in the figure) of the holes 42 at positions facing the mounted areas of the electrode terminals 34 and 36 and the ports 38. The holes 42 with an appropriate size provided at such positions can improve the safety and the handleability of the secondary battery in a balanced manner.

It should be noted that almost all of the gas-retaining portion 16a is covered with the cover 14 in FIG. 8. However, this is not a limitation, and in the case where the thin portion is a part of the gas-retaining portion 16a, only the thin portion may be covered. In this case also, the thin portion may be covered totally or partially.

FIG. 9 shows the thin portion 41 covered with the cover 14. In the example shown in the figure, a lowermost end 14a of the cover 14 is below the lower end of the thin portion 41. By covering the thin portion 41 as above, even when the electrolyte is ejected from the ruptured thin portion 41, droplets of electrolyte will not be scattered horizontally to the right and left, and thus the safety of the battery can be further improved.

### Embodiment 5

Next, Embodiment 5 of the present invention is described. A secondary battery of Embodiment 5 is the same as the secondary batteries of Embodiments 1 to 4 in terms of appearance. The description here is, therefore, given using the same reference numerals as used in FIGS. 1 to 8.

The secondary battery of Embodiment 5 is a battery further comprising a reinforcing member in the battery of each of Embodiments 1 to 4. The reinforcing member is used for increasing the strength of the portion except the thin portion of the battery container, and may be, for example, a tape-like member. The reinforcing member is preferably bonded to the inner surface of the battery container with an adhesive.

The position at which the reinforcing member is to be provided is dependent on the embodiment of the thin portion provided on the gas-retaining portion 16a.

For example, in the battery 10 shown in FIG. 1, in which all of the gas-retaining portion 16a is the thin portion, it is preferable to provide the reinforcing member on the liquid-retaining portion 16b at a portion 16c adjacent to the gas-retaining portion 16a. This can prevent a rupture at the gas-retaining portion 16a from propagating to the liquid-retaining portion 16b. In the battery 10 shown in FIG. 1, it is also preferable to provide the reinforcing member on the inside of an upper end portion 16d of the battery container 16. The upper end portion 16d is a portion at which the leg portion 18a of the lid 18 is welded, and reinforcing this portion can effectively prevent a rupture from propagating throughout the battery container.

Further, in the battery 10 shown in FIG. 1, it is also preferable to provide the reinforcing member across the boundary between the liquid-retaining portion 16b and the gas-retaining portion 16a. By providing the reinforcing member in such a manner, even if fragments of the gas-retaining portion 16a are caused, the fragments are kept attached to the liquid-retaining portion 16b by the reinforcing member. As such, scattering of fragments can be suppressed.

Furthermore, in the battery 10 shown in FIG. 1, in the case where all of the gas-retaining portion 16a on the long-side side walls 52 only is the thin portion, without forming the thin portion on the gas-retaining portion 16a on the short-side side walls 54, it is also preferable to provide the reinforcing member at the gas-retaining portion 16a on the short-side side walls 54. This allows only the long-side side walls 52 of the gas-retaining portion 16a to rupture more reliably. In this case, the reinforcing member may be provided across the boundary between the long-side side wall 52 and the short-side side wall 54. By providing the reinforcing member in such a manner, even when the long-side side wall 52 ruptures to cause fragments thereof, the fragments are kept attached to the short-side side wall 54 by the reinforcing member. As such, scattering of fragments can be suppressed.

In the battery 10A shown in FIG. 4, a reinforcing member 56 may be provided so as to surround the thin portion 41, as shown in FIG. 10. This can prevent a rupture of the thin portion 41 from propagating to the surrounding area.

Further, the reinforcing member 56 may be provided across the boundary between the thin portion 41 and the long-side side wall 52, as shown in FIG. 11. This allows the reinforcing member 56 to function as a hinge, with effects similar to that of FIG. 7.

With regard to the battery 10B shown in FIG. 8, the reinforcing member may be provided at the positions as provided in the batteries 10 and 10A shown in FIGS. 1 and 4, with similar effects.

In order to achieve the effects as described above, a member constituting the reinforcing member preferably has a breaking strength of 37.5 to 150 N/25 mm. The breaking strength is measured by preparing a test piece having a shape as specified by the Japanese Industrial Standard (JIS K 7113, 1995), and elongating the test piece at a tensile rate of 10 mm/min using a tensile tester (e.g., AGS-500B available from Shimadzu Corporation).

Further, the percentage of elongation until break of the member constituting the reinforcing member is preferably 30 to 125%. This prevents the reinforcing member itself from being ruptured by the impact of the rupture of the thin portion. A more preferred range of the percentage of elongation is 100 to 125%. The percentage of elongation is determined by preparing a test piece having a shape as specified by the Japanese Industrial Standard (JIS K 7113, 1995), elongating the test piece at a tensile rate of 10 mm/min using a tensile tester (e.g., AGS-500B available from Shimadzu Corporation), and comparing the dimensions of the test piece immediately before break with the original dimensions of the test piece.

In addition, by bonding the reinforcing member to the battery container 16 with an adhesive, the reinforcing member can be provided at any desired position. This enhances the flexibility of the design.

As a material for the reinforcing member, for example, polyvinyl chloride, polytetrafluoroethylene, imide-based resin, amide-based resin, olefin-based resin, ABS resin, acryl-based resin, silicone-based resin, synthetic rubber, and natural rubber may be used singly and in combination, depending on the specific properties of the electrolyte. Alternatively, a composite material being made of the above-listed resin and ceramic or metal such as copper, iron, nickel, aluminum, or stainless steel and having an appropriate percentage of elongation may be used.

In covering the thin portion with a part of the reinforcing member as shown in FIG. 11, a plurality of reinforcing members may be provided at intervals of 15 to 25 mm. By providing as above, when the thin portion ruptures due to an increase in the internal pressure of the battery container, the gas to eject from inside can be escaped between the reinforcing members, and thus, the rupture of the reinforcing members themselves can be prevented.

The adhesive includes, for example, an acryl-based resin, a synthetic rubber, a rosin derivative, and a terpene-based resin. The adhesion strength of the adhesive is preferably 12.5 to 20 N/25 mm (measured at 23° C.). By setting the lower limit of the adhesion strength to the above value, even when the secondary battery ruptures to cause fragments, the fragments can be more reliably kept attached because of their adhesion to the reinforcing member, and scattering of fragments can be more reliably prevented. By setting the upper limit of the adhesion strength to the above value, if it becomes necessary to remove the lid 18 from the battery container 16, the reinforcing member can be comparatively easily removed, which improves the ease of maintenance.

In the following, examples related to Embodiments 1 to 5 are described. It should be noted, however, that the present invention is not limited to the following examples.

### EXAMPLE 1

Six secondary batteries of model No. 80D26 conforming to JIS D 5301 (starter batteries) were produced as a secondary battery of Example 1. The dimensions of each secondary battery were 260×173×202 mm, and the overall height thereof including the electrode terminals was 225 mm. The number of the chambers (cells) in the battery container was six.

The inside dimension height of the side portion of the battery container was 195 mm, and an electrolyte was filled to a height of 80% of the height. With regard to the thickness of side portion of the battery container, the average thickness of the portion corresponding to 80% of the inside dimension height from the bottom (the liquid-retaining portion) was 2.5 mm, and the thickness of the remaining portion corresponding to 20% from the top (the gas-retaining portion) was 1.5 mm. With regard to the lid, the average thickness of the top plate was 2.3 mm, and the thickness of the leg portion was 3.5 mm.

### EXAMPLE 2

Six secondary batteries were produced in the same manner as in Example 1, except that the average thickness of the gas-retaining portion on the side portion of the battery container was changed to 1.0 mm.

### EXAMPLE 3

Six secondary batteries were produced in the same manner as in Example 1, except that the thickness of the gas-retaining portion on the long-side side walls of the battery container was set to 1.5 mm, and the thickness of the gas-retaining portion on the short-side side walls of the battery container was set to 2.5 mm.

### EXAMPLE 4

A thin portion was formed only on a part of the gas-retaining portion on the long-side side walls of a battery container. The thickness of a portion except the thin portion of the long-side side walls was 2.5 mm. The thin portion was formed in the shape of a rectangle as shown in FIG. 4 such that all the chambers shared the thin portion. The dimensions of the thin portion were 20×240 mm. The first groove was formed along the upper end of the thin portion, and the second groove was formed along the lower end of the thin portion. The thickness of a portion except the grooves of the thin portion was 1.5 mm. The first and second grooves each had a triangular cross-sectional shape. The depths of the first groove and the second groove were 0.2 mm and 0.5 mm, respectively. In addition, a groove having the same depth and cross-sectional shape as the second groove was provided along each of the right and left ends of the thin portion. Six secondary batteries were produced in the same manner as in Example 1, except the above.

### EXAMPLE 5

The lid and 30% from the top of the side portion of the battery container were covered with a cover, as shown in FIG. 8. The cover was in the form of a sheet, and had a thickness of 1.0 mm. The material thereof was polyethylene. Holes were provided at positions facing the electrode terminal-mounted areas and the ports of the lid. Six secondary batteries were produced in the same manner as in Example 1, except the above.

### EXAMPLE 6

A tape-like reinforcing member was adhered to the inside of the side portion of the battery container with an adhesive, across the boundary between the gas-retaining portion and the liquid-retaining portion. The upper end of the reinforcing member was at ⅓ of the height of the gas-retaining portion from the bottom thereof, and the lower end of the reinforcing member was at 1.5 cm from the upper end of the liquid-retaining portion. A polyvinyl chloride tape of 0.2 mm in thickness and 20 mm in width was used as the reinforcing member. An acryl-based resin was used as the adhesive.

The breaking strength of the reinforcing member, the percentage of elongation until the reinforcing member broke, and the adhesion strength of the adhesive were measured prior to assembling. The breaking strength of the reinforcing member was 45 N/25 mm. The percentage of elongation was 100%. The adhesion strength of the adhesive was 12.5 N/25 mm. Six secondary batteries were produced in the same manner as in Example 1, except the above.

### COMPARATIVE EXAMPLE 1

Six secondary batteries were produced in the same manner as in Example 1, except that the thickness of the entire side portion of the battery container was set to 2.5 mm.

Three out of six secondary batteries of each of Examples 1 to 6 and Comparative Example 1 were subjected to a battery container internal pressure increase test as described below, to observe the damage on the battery container by the test. Further, the remaining three secondary batteries were subjected to a drop test as described below, to observe the damage on the battery container by the test. The results are shown in Table 1.

(Internal Pressure Increase Test)

The plug sealing the electrolyte injection port for one of the chambers located in the vicinity of the center of the secondary battery in the longitudinal direction X was removed, and two 0.3-mm-diameter copper wires each being 10 cm long were inserted from outside into the chamber such that the tip ends of the two wires were above the liquid surface of the electrolyte and spaced apart from each other. The tip ends of the two copper wires had been connected to each other with a very thin 0.1-mm-diameter copper wire of 5 mm long. After the insertion of the two copper wires, the electrolyte injection port was sealed with the plug.

Next, the secondary battery was charged with an electric power of 6 A×1 hr or more, and the charge was continued under the same conditions even after the battery was fully charged, so that hydrogen gas and oxygen gas were continuously generated inside the secondary battery. In such a manner, flammable gas was filled in a highly flammable state in each of the chambers in the secondary battery.

In this state, a 10 V voltage was applied at a maximum current of 100 A between the two copper wires whose tip ends were connected with a thin copper wire. Upon breakage of the thin copper wire due to heat generated by voltage application, a spark was generated to cause the flammable gas to ignite, and the internal pressure of the above one of the chambers in the battery container increased abruptly.

(Drop Test)

The secondary batteries were dropped from a height of 1 m to a concrete floor.

TABLE 1

| | | Ratio of | Internal pressure | | Drop |
|---|---|---|---|---|---|
| | | thick- | increase test | | test |
| | Formation | ness | Scattering | Scattering | State of |
| | of thin | of thin | of | of | battery |
| | portion | portion | fragments | electrolyte | container |
| Ex. 1 | All of gas- | 60% | Scattering of | Scattering | Not |
| | retaining | | middle-sized | suppressed | broken |
| | portion on | | fragments | | |
| | side portion | | suppressed | | |
| | of battery | | | | |
| | container | | | | |
| Ex. 2 | Same as Ex. 1 | 40% | Scattering of | Scattering | Not |
| | | | middle-sized | suppressed | broken |
| | | | fragments | | |
| | | | suppressed | | |
| Ex. 3 | All of gas- | 60% | Scattering of | Scattering | Not |
| | retaining | | middle-sized | suppressed | broken |
| | portion on | | fragments | | |
| | long-side | | suppressed | | |
| | side walls | | | | |
| Ex. 4 | Part of gas- | 60% | Scattering of | Scattering | Not |
| | retaining | | small-sized | suppressed | broken |
| | portion on | | fragments | | |
| | long-side | | suppressed | | |
| | side walls | | | | |
| Ex. 5 | Same as | 60% | Scattering of | Scattering | Not |
| | Ex. 1, plus | | middle-sized | suppressed | broken |
| | cover | | fragments | | |
| | | | suppressed | | |
| Ex. 6 | Same as | 60% | Scattering of | Scattering | Not |
| | Ex. 1, plus | | middle-sized | suppressed | broken |
| | reinforcing | | fragments | | |
| | member | | suppressed | | |
| Com. | Not formed | — | Large-sized | Scattered | Not |
| Ex. 1 | | | fragments | | broken |
| | | | scattered | | |
| | | | over large | | |
| | | | area | | |

In the internal pressure increase test, in Comparative Example 1 in which no thin portion was formed, large-sized (approx. 7×7 cm or more) fragments of the lid and battery container were caused. The fragments were vigorously scattered over a large area. Further, since the liquid-retaining portion was broken, the electrolyte spilled therefrom, and the droplets of electrolyte were scattered around. In the drop test, the battery container was not broken.

In contrast, in Example 1 in which the thin portion was formed on all of the gas-retaining portion on the side portion of the battery container, middle-sized (3 to 7×3 to 7 cm) fragments of the thin portion were caused, but scattering of the fragments were suppressed as compared to in Comparative Example 1. Since the fragments were of the thin portion, the thicknesses thereof were smaller than that in Comparative Example 1. In the drop test also, the battery container was not broken. Example 2 in which the thickness of the thin portion was slightly changed exhibited results similar to the above. In Examples 3 to 6 also, the battery container was not broken.

Example 3 in which the thin portion was formed on all of the gas-retaining portion on the long-side side walls exhibited results almost similar to those of Example 1. In contrast to Example 2 in which the short-side side walls were also broken, the short-side side walls were not broken in Example 3.

In Example 4, although the area of the thin portion was smaller than that in Examples 1 to 3, the thin portion was provided with grooves along the upper and lower ends thereof such that the lower end groove was deeper than the other, and therefore, the portion along the lower end groove ruptured quite early, and the rupture at the portion did not propagate to the other portion. As a result, the scatted fragments were small in size (3×3 cm or less), and scattering thereof was suppressed. The portion along the upper end of the thin portion remained unruptured and functioned like a hinge, the thin portion opened obliquely downward. As a result, almost all of the droplets of electrolyte were ejected obliquely downward and not scattered over a large area.

In Example 5, the gas-retaining portion and the lid were covered with a cover made of polyethylene. As a result, scattering of fragments and electrolyte was prevented almost completely. In Example 6 in which a reinforcing member was provided across the boundary between the gas-retaining portion and the liquid-retaining portion, some of the fragments of the gas-retaining portion of the battery container were kept attached to the liquid-retaining portion by the reinforcing member. As a result, scattering of fragments was more suppressed than in Example 1.

### Embodiment 6

Next, Embodiment 6 is described with reference to FIGS. 12 and 13. FIG. 12 is an oblique view showing the appearance of a secondary battery according to Embodiment 6. FIG. 13 is an oblique view showing the internal structure of the secondary battery according to Embodiment 6. In FIG. 13, the battery container is partially cut away to show the internal structure of the secondary battery.

In a battery 10C shown in the figure includes a predetermined number of (“six” in the example shown in the figure) thin portions 42 on the gas-retaining portion 16a on the upper portions of the pair of the long-side side walls 52. The thin portions 42 are provided one by one in each of the chambers 42. By providing the thin portions 42 independently in each of the chambers 42, even if the chambers 22 are filled with flammable gas generated by misuse such as overcharging or reverse connection of the secondary battery, and the flammable gas in one of the chambers 22 ignites to cause the internal pressure thereof to increase abruptly, it is possible to allow the thin portion 22 provided in the chamber 22 to rupture early, and thus to decrease the internal pressure.

This prevents the partitions between the chambers 22 from being broken. As a result, it is possible to prevent the ignition of flammable gas from propagating to all the chambers 22 to increase the magnitude of the rupture. Therefore, the breakage of the battery container can be confined in a portion defined by one chamber 22, and thus, scattering of fragments and electrolyte can be suppressed.

Further, in the battery 10C, the thin portions 42 are arranged in a staggered arrangement between the pair of the long-side side walls 52. In other words, one of the thin portions 42 of two of the chambers 22 adjacent to each other is provided on one of the pair of long-side side walls 52, and the other of the thin portions 22 is provided on the other of the pair of long-side side walls 52. In short, the thin portions 42 of each of the chambers 22 are provided alternately on the pair of long-side side walls 52.

By arranging the thin portions 42 in a staggered arrangement between the pair of the long-side side walls 52, the distance L between the thin portions 42 adjacent to each other is increased. As such, if one of the thin portions 42 ruptures, it will not propagate to other thin portions 42 adjacent thereto. Hence, breakage of the battery container can be further suppressed, and scattering of fragments and electrolyte can be more effectively suppressed.

In embodiment 6 also, the ratio of the average thickness D1 of the thin portions 42 to the average thickness D2 of the long-side side walls 52 excluding the thin portions 42 may be set, for example, 40 to 60%, although not limited thereto. Likewise, the ratio of the average tensile strength of the thin portions 42 to the average tensile strength of the long-side side walls 52 excluding the thin portions 42 may be set, for example, 60 to 70%, although not limited thereto.

As described above, in this embodiment, the thin portions 42 of each of the chambers 22 are arranged in a staggered arrangement between the pair of long-side side walls 52, rather than aligning the thin portions 42 in a line on one of the long-side side walls 52. As such, the distance between the thin portions 42 adjacent to each other is increased. As such, even if the flammable gas ignites in one chamber 22, and the internal pressure thereof increases abruptly, causing the thin portion 42 in the chamber 22 to rupture, since the thin portion 42 in the chamber 22 adjacent thereto is arranged on the long-side side wall on the opposite side, the rupture is unlikely to propagate to the thin portion 42 in the adjacent chamber 22, and thus, breakage of the battery container can be suppressed. Therefore, scattering of fragments and electrolyte can be suppressed.

It should be noted that the thin portions 42 are arranged in a staggered arrangement between the pair of long-side side walls 52 in this embodiment, but this is not a limitation. For example, the thin portions 42 may be arranged in a staggered arrangement on one of the long-side side walls 52 by, for example, alternating the vertical positions of the thin portions 42 adjacent to each other.

It should be further noted that the feature of this embodiment may be combined with the feature of the battery 10A of Embodiment 3 shown in FIG. 4. Specifically, the thin portion having grooves along the upper and lower ends thereof as shown in FIG. 5 may be provided independently in each of the chambers 22. Further, such thin portions may be arranged in a staggered arrangement.

### Embodiment 7

Next, Embodiment 7 of the present invention is described with reference to FIG. 14. In a battery 10D of Embodiment 7, the thin portions 42 are provided on the top plate 18a of the lid 18, instead of on the long-side side walls 52. The electrolyte injection ports 38 are arranged on top surface of the top plate 18a at equal intervals along the longitudinal direction X in the center in the lateral direction Y, instead of at positions closer to one side in the lateral direction Y.

The thin portions 42 are provided independently in each of the chambers 22, and at least some of the thin portions 42 of each of the chambers 22 (i.e., four thin portions 42, 42₁ to 42₄, in the example shown in the figure) are arranged in a staggered arrangement on the top plate 18a.

In the case where the thin portions 42 are provided on the lid 18 also, arranging the thin portions 42 of each of the chambers 22 in a staggered arrangement can increase the distance between the thin portions 22 in the chamber 22 adjacent to each other. As a result, a rupture will not propagate among the thin portions 42.

In the example shown in the figure, some of the thin portions 42 (i.e., two thin portions 42, 42₅ and 42₆) are not arranged in a staggered arrangement. However, for example, the positions of the electrode terminal 36 and the electrolyte injection ports 38 may be moved, so that all the thin portions 42 can be arranged in a staggered arrangement.

### Embodiment 8

Next, Embodiment 8 of the present invention is described with reference to FIG. 15. In a battery 10E of Embodiment 8, a pair of thin portions is provided in each chamber 22. Specifically, although not explicitly shown in the figure, in each of the chambers 22, a strong thin portion 44 is provided on one of the pair of long-side side walls 52, and a weak thin portion 46 is provided on the other of the pair of long-side side walls 52. The strong thin portion 44 is a thin portion which is higher in strength (tensile strength) than the weak thin portion 46, and the average thickness of the thin portions 44 is larger than that of the weak thin portions 46.

One of the weak thin portions 46 of two of the chambers 22 adjacent to each other is provided on one of the pair of long-side side walls 52, and the other of the weak thin portions 46 of two of the chambers 22 adjacent to each other is provided on the other of the pair of long-side side walls 52. Specifically, on each long-side side wall 52, the strong thin portion 44 is alternated with the weak thin portion 46, so that the strong thin portions 44 or the weak thin portions 46 are not adjacent to each other.

When focusing on the strong thin portions 44 of each of the chambers 22, the strong thin portions 44 are arranged in a staggered arrangement between the pair of long-side side walls 52. Likewise, when focusing on the weak thin portions 46 of each of the chambers 22, the weak thin portions 46 are arranged in a staggered arrangement between the pair of long-side side walls 52.

By alternating the strong thin portion 44 with the weak thin portion 46 on each of the long-side side walls 52, the distance between the weak thin portions 46, which are considered to break early, can be increased. As a result, a rupture of the weak thin portion 46 in one of the chambers 22 is unlikely to propagate to the weak thin portions 46 in the chambers adjacent thereto, and breakage of the battery container can be suppressed.

For example, the average thickness of the weak thin portions 46 may be 40% of that of the portion except the thin portions of each long-side side wall 52, and the average thickness of the strong thin portions 44 may be 60% of that of the portion except the thin portions of each long-side side wall 52.

In the following, examples related to Embodiments 7 and 8 are described. It should be noted, however, that the present invention is not limited to the following examples.

### EXAMPLE 7

The inner wall of one or the other of a pair of long-side side walls of each chamber was recessed such that the thickness of 20% of the long-side side wall from the top was 60% of the thickness of the other portion, whereby thin portions having an average thickness of 1.5 mm were formed independently in each of the chambers. One of the thin portions of two of the chambers adjacent to each other was provided on one of the pair of long-side side walls, and the other of the thin portions was provided on the other of the pair of long-side side walls, so that the thin portions were arranged in a staggered arrangement between the pair of long-sided side walls. Six secondary batteries were produced in the same manner as in Example 1, except the above.

### EXAMPLE 8

Six secondary batteries were produced in the same manner as in Example 1, except the average thickness of the thin portions was changed to 1 mm (i.e., 40% of the thickness of the other portion).

### COMPARATIVE EXAMPLE 2

Six secondary batteries were produced in the same manner as in Example 1, except that no thin portion was provided.

Three out of six secondary batteries of each of Examples 7 and 8 and Comparative Example 2 were subjected to the above-described internal pressure increase test, to observe the damage on the battery container by the test. The remaining three secondary batteries were subjected to the above-describe drop test, to observe the damage on the battery container by the test. The results are shown in Table 2.

TABLE 2

| | Ratio of | | | | |
|---|---|---|---|---|---|
| | thickness | | | | |
| | of thin | Size of | Scattering of | Scattering of | Result of |
| | portion | fragments | fragments | electrolyte | drop test |
| Ex. 7 | 60% | Small | Suppressed | Suppressed | Not |
| | | | | | broken |
| Ex. 8 | 40% | Small | Suppressed | Suppressed | Not |
| | | | | | broken |
| Com. | — | Large | Fragments | Electrolyte | Not |
| Ex. 2 | | | scattered over | scattered over | broken |
| | | | large area | large area | |

In Comparative Example 2 in which no thin portion was provided, as a result of the internal pressure increase test, the partitions of the chamber in which the flammable gas was forced to ignite by a spark were broken, and the internal gas in the chambers adjacent thereto ignited one after another, to cause large-sized fragments (approx. 7×7 cm or more) of the battery container. The fragments were vigorously scattered over a large area. In addition, not only the gas-retaining portion but also the liquid-retaining portion of the battery container were broken, which caused the electrolyte to spill out and a comparatively large amount of droplets of electrolyte to disperse over a large area.

In contrast, in Examples 7 and 8 in which the thin portions were provided independently in each of the chambers in a staggered arrangement between the pair of long-side side walls, as a result of the internal pressure increase test, only the thin portion in the chamber in which the flammable gas was forced to ignite by a spark were broken. The size of fragments caused by the breakage was small (approx. 3×3 cm or less). The distance over which the fragments were scattered was shorter than in Comparative Example 2. In addition, because of the formation of the thin portions on the gas-retaining portion of the battery container, the liquid-retaining portion was not broken, and spillage of electrolyte was prevented. The amount of electrolyte scattered around was smaller than in Comparative Example 2.

As a result of the drop test, in Comparative Example 2 in which no thin portion was provided, the battery container was not broken at all, and in Examples 7 and 8 in which the thin portion was provided, the battery container was not broken, too.

The above results confirmed that by setting the strength of the thin portions in a balanced manner, it is possible to suppress scattering of electrolyte and the like due to an increase in the internal pressure, and simultaneously to keep the battery container strong enough to withstand normal use.

### Embodiment 9

Next, Embodiment 9 of the present invention is described with reference to FIGS. 16 to 19. FIG. 16 is an oblique view showing the schematic configuration of a secondary battery according to Embodiment 9. FIG. 17 is an oblique view showing the internal structure of the same secondary battery. FIG. 18 is a fragmentary cross-sectional view taken along the line XVIII-XVIII in FIG. 16. FIG. 19 is an enlarged cross-sectional view of a thin portion. In FIG. 17, the case and lid are partially cut away to show the inner structure of the secondary battery.

In a battery 10F shown in the figure, thin portions 43 corresponding to each of the chambers 22 are provided on the top plate 18a at equal intervals in parallel to the longitudinal direction Y at positions closer to one side in the lateral direction Y.

The thin portion 43 is formed by providing a recess 45 with a flat bottom, on the outside surface of the top plate 18a. The recess 45 has a substantially rectangular shape when viewed from above. The width of the bottom portion, that is, the length of the short side, is preferably set to 10 to 90 mm. The aspect ratio is preferably set to 3:2 to 4:1.

The chamber 22, when viewed from above, has a substantially rectangular shape, whose longitudinal direction is along the lateral direction Y. The longitudinal direction of the recess 45 is also along the lateral direction Y, and the longitudinal direction of the chamber 22 when viewed from above is parallel to the longitudinal direction of the recess 45.

In the recess 45, a protection member 47 made of, for example, a gel material (e.g., αGEL (registered trademark), available from Taica Corporation), a rubber sheet, a fabric such as nonwoven fabric, or a soft resin material is arranged.

The protective member 47 may be fixed in the recess 45 in any manner without limitation. In the case where the protective member 47 is made of a material having a certain degree of rigidity, such as a rubber sheet or a soft resin material, it may be fixed by forming the protective member 47 in almost the same shape as that of the recess 45, and simply fitting the protective member 47 into the recess 45.

In the case where the protective member 47 is fixed onto the bottom of the recess 45 with a joining material (e.g., a double-sided tape) 48, the area of the joining material 48 when viewed from above is preferably smaller than that of the recess 45 when viewed from above, as shown in FIG. 19. For example, the ratio of the area of the joining material 48 when viewed from above to that of the recess 45 is preferably set to 3 to 25%.

When the above ratio is set to 25% or less, it will not happen that the strength of the thin portion 43 is increased by joining the protective member 47 thereto to such an extent that early rupture of the thin portion 43 is prevented. On the other hand, when the above ratio is 3% or more, it will not happen that the protective member 47 easily falls off from the recess 45. The thin portions 43 of Embodiment 9 may be provided on the side portion of the battery container, or alternatively, may be formed on the lid 18 in a staggered arrangement, as shown in FIG. 14. The protective member 47 may be similarly applied to the thin portion in any of the above-described Embodiments.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The secondary battery of the present invention is useful when used as a vehicle-mounted power source, a power source for driving various portable electronic devices, or a power source for power storage equipment. It is particularly useful when it is a secondary battery which is not formed into a battery pack and whose safety depends on how it is used by the user, such as a lead-acid battery.

### REFERENCE SIGNS LIST

10, 10A, 10B, 10C, 10D, 10F . . . Secondary battery
16 . . . Accommodating portion
16a . . . Gas-retaining portion
16b . . . Liquid-retaining portion
18 . . . Lid
22 . . . Chamber,
24 . . . Electrode group
41, 42, 43 . . . Thin portion,
41a . . . First groove
41b . . . Second groove
44 . . . Strong thin portion
45 . . . Recess
46 . . . Weak thin portion
47 . . . Protective member
52 . . . Long-side side wall
54 . . . Short-side side wall

1. A secondary battery comprising: an electrode group including a positive electrode, a negative electrode, and a separator; an electrolyte; and a battery container including an accommodating portion having an opening and accommodating the electrode group and the electrolyte, and a lid sealing the opening of the accommodating portion, wherein
the battery container includes a liquid-retaining portion retaining the electrolyte therein below a liquid surface of the electrolyte, and a gas-retaining portion retaining gas therein above the liquid surface of the electrolyte, and
a thin portion is formed on the liquid-retaining portion of the accommodating portion.

2. The secondary battery in accordance with claim 1, wherein
an interior of the battery container is divided into a plurality of chambers by at least one partition,
each of the chambers accommodates the electrode group and the electrolyte, and
the thin portion is formed on the gas-retaining portion of the accommodating portion independently in each of the chambers.

3. The secondary battery in accordance with claim 2, wherein the accommodating portion includes a substantially rectangular bottom portion having a pair of long sides and a pair of short sides; and a side portion having a pair of short-side side walls being opposite to each other and being raised from the pair of short sides of the bottom portion, and a pair of long-side side walls being opposite to each other and being raised from the pair of long sides of the bottom portion, and
wherein the at least one partition is in the fonn of a plate and substantially parallel to the pair of short-side side walls; and the thin portions are formed in a staggered arrangement on the long-side side walls.

4. The secondary battery in accordance with claim 3, wherein one of the thin portions of two of the chambers adjacent to each other is provided on one of the pair of long-side side walls, and the other of the thin portions of two of the chambers adjacent to each other is provided on the other of the pair of long-side side walls.

5. (canceled)

6. The secondary battery in accordance with claim 1, wherein the thin portion has a substantially rectangular shape with an upper end and a lower end; the thin portion has a first groove formed along the upper end and a second groove formed along the lower end; and the second groove is deeper than the first groove.

7. The secondary battery in accordance with claim 1, wherein the thin portion is formed by providing a recess on an outer surface of the gas-retaining portion, and a protective member for protecting the thin portion is arranged in the recess.

8. The secondary battery in accordance with claim 7, wherein the protective member comprises at least one selected from the group consisting of a gel material, a rubber sheet, a fabric, and a soft resin material.

9. The secondary battery in accordance with claim 7, wherein the recess has a flat bottom, and 90% or more of the bottom is covered with the protective member.

10. The secondary battery in accordance with claim 9, wherein the protective member is in the form of a plate and has a thickness equal to or shorter than a maximum depth of the recess.

11. The secondary battery in accordance with claim 1, wherein the accommodating portion includes a substantially rectangular bottom portion having a pair of long sides and a pair of short sides; and a side portion having a pair of short-side side walls being opposite to each other and being raised from the pair of short sides of the bottom portion, and a pair of long-side side walls being opposite to each other and being raised from the pair of long sides of the bottom portion, and
wherein the at least one partition is in the form of a plate and is substantially parallel to the pair of short-side side walls; in each of the chambers, a strong thin portion having a comparatively higher strength is provided on one of the pair of long-side side walls, and a weak thin portion having a comparatively lower strength is provided on the other of the pair of long-side side walls; and one of the strong thin portions of two of the chambers adjacent to each other is provided on one of the pair of long-side side walls, and the other of the strong thin portions of two of the chambers adjacent to each other is provided on the other of the pair of long-side side walls.

12. A secondary battery comprising: an electrode group including a positive electrode, a negative electrode, and a separator; an electrolyte; and a battery container including an accommodating portion having an opening and accommodating the electrode group and the electrolyte, and a lid sealing the opening of the accommodating portion,
wherein the battery container includes a liquid-retaining portion retaining the electrolyte therein below a liquid surface of the electrolyte, and a gas-retaining portion retaining gas therein above the liquid surface of the electrolyte, and
the liquid-retaining portion has a thin portion,
wherein the accommodating portion includes a substantially rectangular bottom portion having a pair of long sides and a pair of short sides; and a side portion having a pair of short-side side walls being opposite to each other and being raised from the pair of short sides of the bottom portion, and a pair of long-side side walls being opposite to each other and being raised from the pair of long sides of the bottom portion, and
wherein the at least one partition is in the form of a plate and substantially parallel to the pair of short-side side walls; in each of the chambers, a strong thin portion having a comparatively higher strength and a weak thin portion having a comparatively lower strength are provided on the lid; and one of the thin portions of two of the chambers adjacent to each other is provided on the lid at a position closer to one of the pair of long-side side walls, and the other of the thin portions of two of the chambers adjacent to each other is provided on the lid at a position closer to the other of the pair of long-side side walls.
